(19) United States
(12) Patent Application Publication
(10) Pub. No.: US 2017/0361582 A1
(43) Pub. Date: Dec. 21, 2017

(54) MULTILAYER PLASTIC FILM

(71) Applicant: MACRO TECHNOLOGY INC., Mississauga (CA)

(72) Inventors: Miroslav Planeta, Mississauga (CA); Harinder Tamber, Brampton (CA)

(21) Appl. No.: 15/533,316

(22) PCT Filed: Dec. 4, 2015
(86) PCT No.: PCT/CA2015/051273

§ 371 Date: Jun. 5, 2017

Related U.S. Application Data
(60) Provisional application No. 62/088,266, filed on Dec. 5, 2014.

(51) Int. Cl. B32B 27/08; B32B 27/30; B32B 37/15; B32B 27/32; B32B 27/34; B65D 65/40; B65D 1/02

(52) U.S. Cl. CPC B32B 27/08; B65D 65/40; B32B 27/304; B65D 1/0215; B32B 27/306; B32B 27/308; B32B 27/325; B32B 27/327; B32B 27/34; B32B 37/153; B32B 2307/54; B32B 2307/518; B32B 2274/00; B32B 2307/7244; B32B 2439/70; B32B 2307/736; B32B 2307/738; B32B 2439/06; B32B 2439/46; B32B 2307/7246

(57) ABSTRACT

A novel multilayer plastic film is provided comprising a series of component layers and optionally bonding layers to tie said component layers together, said component layers comprising: a central oxygen barrier layer, a first polymeric barrier layer on a first side of said central oxygen barrier layer, a second polymeric barrier layer on a second side of said central oxygen barrier layer, an outer layer adjacent the first polymeric barrier layer for providing mechanical strength, and a sealant layer adjacent the second polymeric barrier layer. At least one layer comprises two different polymers.

### FIELD OF THE INVENTION

The present application generally relates to the field of multilayer plastic films or sheets, and in particular, relates to multilayer plastic films or sheets with improved moisture or oxygen barrier core properties, or improved mechanical properties.

### BACKGROUND OF THE INVENTION

Multilayer high shrink plastic films have use in areas such as food packaging. To maintain freshness, colour, and other properties, the multilayer high shrink plastic films must create a barrier against moisture, gases (such as oxygen), and aroma. In addition, the multilayer high shrink plastic film should exhibit mechanical properties such as puncture resistance, and high tear and tensile strength. This ensures packaged food is not damaged during processing and transport.

U.S. Pat. No. 5,336,549 describes a multilayer heat shrinkable plastic film comprised of core layers of ethylene vinyl alcohol (EVOH) and polyamide (PA or Nylon) surrounded by a thin polyethylene terephthalate (PET) outside layer and a thin adhesive layer. While the core layers of EVOH and PA provide oxygen barrier properties, the outside PET layer and adhesive layer have low moisture barrier properties. Accordingly, the permeation of moisture through the outside layers at three different stages during processing exposes the core layers to water. The permeation of moisture to the core layers of EVOH and PA leads to a higher oxygen transmission rate, and accordingly, to a deterioration of the oxygen barrier properties and mechanical properties of the film.

U.S. Pat. No. 5,079,051 discloses polyvinylidene chloride (PVdC) which functions as both an oxygen and moisture barrier. However, the oxygen barrier properties of PVdC are inferior to the oxygen barrier properties of EVOH, particularly in conditions of lower relative humidity. Additionally, PVdC is difficult to process on larger dies.

US Patent Application US2010/0003432A1 and EU Patent EP 2351645A1 issued on Apr. 3, 2013 (collectively “Schiffman”) disclose thermoplastic materials of different thicknesses surrounding core layers of EVOH and/or PA to reduce the exposure of moisture to the core layers of EVOH and PA. These thermoplastic materials include polypropylene (PP), polyethylene (PE), polystyrene (PS), and polyethylene terephthalate)-glycol (PETG). However, these materials have low moisture barrier properties, exposing the core layers of EVOH and PA to moisture. Because relative humidity (RH) affects the oxygen barrier properties of EVOH and PA, the exposure to moisture leads to a decrease in the oxygen barrier and/or mechanical properties of the core layers.

In some cases, the percentage of polyolefin can be increased in a film on the side exposed to more moisture (or higher RH %). However, this percentage increase in one layer in a biaxially oriented shrink film is not viable because of the resultant asymmetrical structure leading to curling and orientation issues of the multilayer film.

In other cases, as disclosed in Schiffman, the core EVOH or Nylon layer may be protected with a blend of cyclic olefin copolymers (COC) and PE, but only from one side since COC is a rigid material. This leaves the other side of the Nylon/EVOH layer protected with only a PE-based sealant, which leads to undesirable moisture exposure to the EVOH or Nylon layer.

U.S. Pat. No. 8,012,572 B2 discloses a micro-layer section for increased flexibility comprising EVOH and PA micro-layers. Similar to above, as both EVOH and PA are hydrophilic and thus absorb moisture, both suffer from a decline in their oxygen barrier properties when exposed to moisture. The film also suffers from a decline in its mechanical properties.

It is known to use the double bubble process, optionally with a third bubble for annealing processes for film fabrication. Two to three layers of PA and EVOH (e.g., PA/EVOH or PA/EVOH/PA) are often placed next to each other as a block of rigid hydrophilic polymers. Although the final film is between about 25 to about 120 microns, the primary tube, prior to orientation, is thicker at 300 to 900 microns. During processing, the primary tube is often cooled below the glass transition temperature of PA and EVOH, which are 50° C. and 60° C., respectively. This cooling leads to a glassy state of the polymers and increases the stiffness of the primary tube. Subsequent collapsing and nipping of the thick primary tube with glassy and rigid PA/EVOH polymers can increase the tendency of flex cracking in the primary tube, which in turn, leads to a loss in the mechanical and barrier properties of the final film after orientation.

The co-extrusion of PA and EVOH as one block of rigid hydrophilic polymers, for example, PA/EVOH or PA/EVOH/PA, may also lead to the block being a moisture sink. The absorption of moisture from any layer on either side can affect all layers. In particular, a large block of hydrophilic polymers may provide a positive driving factor for moisture molecules to travel toward the core block of the moisture sensitive polymers. The result of a high water vapour transmission rate (WVTR) is a decline in the oxygen barrier properties of EVOH and PA. It also leads to a decline in the mechanical properties, such as tensile strength and puncture resistance, of PA.

Accordingly, a need exists for a multilayer shrink film which overcomes at least one of the disadvantages of existing multilayer films, for example, a multilayer film with improved oxygen barrier or moisture barrier properties, or improved mechanical properties.

### SUMMARY OF THE INVENTION

Novel multilayer barrier films or sheets are provided which possess core barrier layers as well as surrounding layers which enhance the strength of the film. The barrier films are particularly useful for food packaging. The use of such barrier films advantageously preserves the product being packaged by providing oxygen, aroma and/or moisture barriers, while additionally exhibiting desirable mechanical properties.

Thus, in one aspect of the present disclosure, a multilayer plastic film or sheet having a series of component layers and optional bonding layers tying said component layers together is provided. The multilayer film or sheet comprises a central oxygen barrier layer, a first polymeric barrier layer on a first side of the central oxygen barrier layer, a second polymeric barrier layer on a second side of the central oxygen barrier layer, an outer layer adjacent the first polymeric barrier layer, and a sealant layer adjacent the second polymeric barrier layer. At least one of the layers is comprised of two or more different polymer layers.

This and other aspects of the invention are described by reference to the detailed description that follows and the drawings.

### BRIEF DESCRIPTION OF THE DRAWINGS

FIG. 1 illustrates the oxygen and moisture barrier properties of select polymers;

FIG. 2 illustrates the effect of relative humidity on the oxygen barrier properties of select exemplary core layers;

FIG. 3 illustrates the dependence of oxygen permeability properties of select polymers on relative humidity;

FIG. 4 is a schematic drawing showing the production of a biaxially oriented heat shrinkable multilayer plastic film in accordance with an embodiment of the invention by means of a double bubble blown process with an optional third bubble for annealing;

FIG. 5 is a schematic drawing showing the production of multilayer plastic film in accordance with an embodiment of the invention by means of a single bubble blown process;

FIG. 6 is a schematic drawing showing the production of a multilayer plastic film in accordance with an embodiment of the invention by means of a cast/sheet process;

FIG. 7 is a schematic drawing showing the production of a multilayer plastic film in accordance with an embodiment of the invention by means of an extrusion coating/lamination process;

FIG. 8 is a schematic drawing showing the production of a biaxially oriented heat shrinkable multilayer plastic film in accordance with an embodiment (water reheat method) of the invention by means of a double bubble blown process with a third bubble for annealing;

FIG. 9 is a schematic drawing showing the production of a biaxially oriented heat shrinkable multilayer plastic film in accordance with an embodiment (infra-red reheat method) of the invention by means of a double bubble blown process with a third bubble for annealing;

FIG. 10 illustrates a schematic of exemplary film structures in accordance with embodiments of the invention.

### DETAILED DESCRIPTION OF THE INVENTION

A novel multilayer plastic film or sheet is provided comprising a series of component layers and optionally bonding layers tying said component layers together. The multilayer film or sheet comprises a central oxygen barrier layer, a first polymeric barrier layer on a first side of the central oxygen barrier layer, and a second polymeric barrier layer on a second side of the central oxygen barrier layer, an outer layer adjacent the first polymeric barrier layer, and a sealant layer adjacent the second polymeric barrier layer. At least one layer of the film or sheet is comprised of two or more layers incorporating different polymers, e.g. a micro-block or a nano-block.

A micro-block comprises between 2 to 40 polymeric layers in which each layer of the micro-block is a micro-layer having a thickness of at least about 0.01 microns to about 1.25 microns in thickness. The thickness of each micro-layer block will generally be in the range of about 0.4 microns to about 50 microns for a film and up to about 500 microns if incorporated in a sheet. A nano-block comprises between about 40 to 400 polymeric layers. Each nano-layer in the nano-block may be at least about 0.001 microns to about 0.125 microns. The thickness of each nano-block will generally be in the range of about 0.4 microns to about 50 microns for a film, and up to about 500 microns if incorporated in a sheet. A micro-block or nano-block comprises at least 2 different polymers, and up to 5 different polymers, which may be from the same or different resin families. Micro- and nano-blocks may be symmetrical and comprise an equal number of each layer, e.g. polymer 1-polymer 2-polymer 1-polymer 2, or they may be asymmetrical and comprise an unequal number of each polymer layer, e.g. polymer 1-polymer 2-polymer 1.

Inclusion of a micro-block or nano-block as a layer in the present film advantageously provides the layer with two or more desirable properties. For example, the properties of the central oxygen barrier layer may be enhanced when provided as a micro- or nano-block due to the inclusion of different layers having complementary properties, e.g. oxygen and moisture barrier properties. Alternatively or additionally, the outer layer may be a micro-block or a nano-block, for example, comprising polymers for heat resistance and abuse resistance. Similarly, use of a micro- or nano-block may enhance the mechanical properties of the film, e.g. to provide strength and flexibility. A micro-block or nano-block may be readily prepared in a multi-layer film as they can be incorporated in existing dies. For example, a 5-layer die can make a 50 layer film using micro-blocks via encapsulation.

The layers of the present multi-layer film may be tied or bonded together with bonding or tie layers, for example, a tie layer may bond the outer layer to a bulk layer or first polymeric layer, the first polymeric layer to the central core barrier layer, the central barrier layer to the second polymeric layer, and the second polymeric layer to the sealant layer, and may bond additional optional layers to any of these layers, e.g. bulk and shrink layers. Each bonding layer may have a thickness in the range of from about 1 to about 10 microns. Suitable polymers for bonding include polymers selected from: ethylene vinyl acetate-maleic anhydride copolymer, ethylene methyl acrylate-maleic anhydride, LDPE-maleic anhydride, LLDPE-maleic anhydride or acid copolymer. The bonding polymer or resin may also be blended with PP, HDPE, COC or LLDPE. For example, the bonding layer may comprise ethylene-vinyl acetate copolymer with a melt index about 0.1 to about 6.0 decigram per minute and a vinyl acetate content of from 9 to about 28 percent by weight. Bonding or tie layers may also be used to bond layers within a micro- or nano-block. In one embodiment, the bonding layer may be combined with a polyamide (PA) or nylon layer in micro-layer structure to make PA₁-tie₁-PA₂-tie₂-PA₃-tie₃ as a first or second polymeric layer. PA may be PA6, PA666, PA612, PA66, aromatic PA or a blend. Alternatively, in the central core barrier layer, EVOH may be bonded with a tie layer to a second barrier layer, e.g. PANMA-im or PVdC, or a micro- or nano-block.

The bonding or tie layers may also be selected for their properties. For example, the bonding or tie layers may be hydrophobic to limit moisture exposure to the central oxygen barrier layer, e.g. EVOH, that may otherwise exhibit a decline in oxygen barrier properties when exposed to high RH. The tie layers may also be a cushion layer. Further, the tie layers may be different thicknesses and of different resin blends to provide flexibility to the primary tube. The tie layer may be further selected from the group comprising: maleic anhydride modified LLDPE, LDPE, EVA or EMA and could be blended with PE, HDPE, PP or COC to further enhance its moisture barrier properties.

The present multi-layer film may have a total thickness of from about 5 microns to about 300 microns, preferably a thickness of from about 25 to about 150 microns, and more preferably, a thickness of from about 25-100 microns. The multi-layer film may also exhibit shrinkage from about 5% to 40% at 90° C. (when produced using a double bubble with annealing process). If a multi-layer sheet is formed using extrusion processes such as east or blown sheet, the multilayer sheet may have a total thickness from about 250 microns to about 5000 microns.

The central oxygen barrier layer provides a primary oxygen and aroma barrier which inhibits the permeation of gases such as oxygen into a product packaged with the present multi-layer film, and inhibits the permeation of aroma out of the packaged product. The central oxygen barrier layer of the present multi-layer film may comprise any polymer that exhibits oxygen barrier properties (e.g. which exhibit an oxygen permeability of no more than about 2.5 cc mil/100 in² per day, and preferably an oxygen permeability of less than 2, e.g. less than 1 cc mil/100 in² per day). Examples of suitable polymers include, but are not limited to, ethylene vinyl acetate copolymer (EVOH), polyvinylidene chloride (PVdC), impact modified acrylonitrile-methyl acrylate copolymer (PANMA-im) (Barex®), polyamide (Nylon) and mixtures thereof. The central barrier layer may comprise a single layer, two or more layers, a microblock, a nanoblock, or a combination thereof, e.g. single or multiple layers with a micro- or nano-block on either side, or a micro- or nano-block with single or multiple layers on either side. The thickness of the central oxygen barrier layer may be in the range of from about 1 to about 24 microns, preferably from about 2 to about 20 microns.

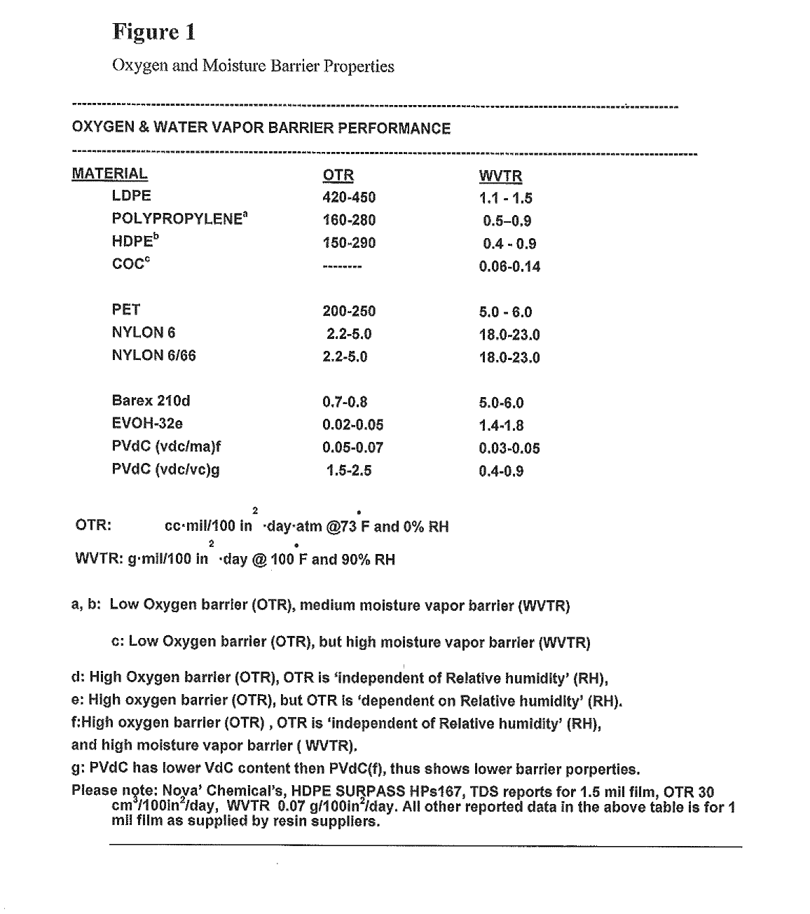

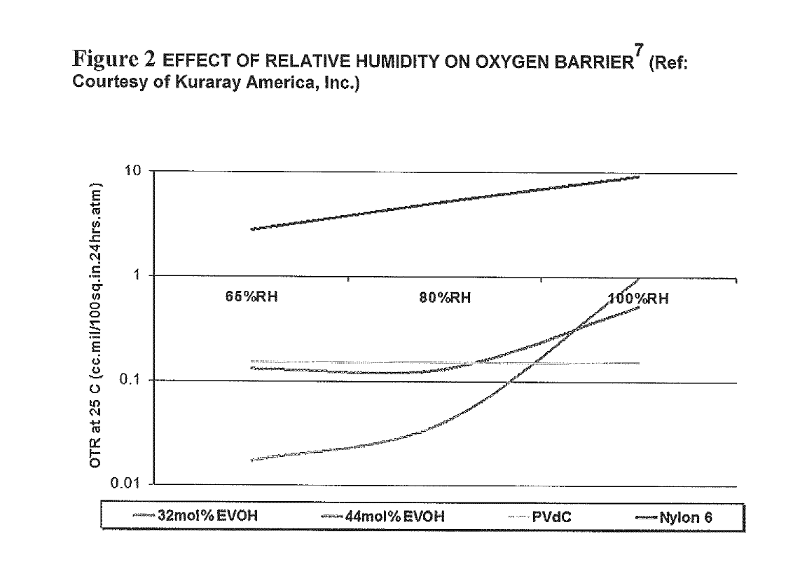

The central barrier layer may comprise EVOH, e.g., EVOH-32 and EVOH-44, exhibits oxygen barrier properties as shown in FIGS. 1 and 2. While the oxygen barrier property of EVOH is dependent on relative humidity (RH) (see FIGS. 1 and 2 showing the effect of relative humidity on the oxygen barrier properties of certain materials), EVOH is also a non-chlorinated polymer. Accordingly, although hydrophilic, EVOH is characterized by its high oxygen barrier property. A central EVOH layer may comprise an ethylene content of varying amounts, for example, an ethylene content of from about 24% to about 48% (saponification greater than 98%), preferably from about 29% to about 44%, with a melt index (MI) of from about 0.5MI to 10MI, preferably from about 1.6MI to 6MI. In one embodiment, an EVOH oxygen barrier layer comprises hydrolyzed ethylene-vinyl acetate copolymer (saponification of up to or greater than 98%) with an ethylene content from about 27 to 48 mole percent.

The central barrier layer may comprise of PVdC having high oxygen barrier properties as shown in FIGS. 1 and 2. Advantageously, the oxygen barrier properties of PVdC are not significantly affected by relative humidity. PVdC is additionally a moisture barrier material, showing superior moisture barrier properties. The PVdC layer may comprise from about 70% to about 98% by weight of vinylidene chloride, preferably from about 85% to about 98% by weight of vinylidene chloride, and from about 2% to about 30% by weight of at least one unsaturated monomer which is copolymerizable with vinylidene chloride, such as methyl acrylate or vinyl chloride. As one skilled in the art will appreciate, a greater amount of vinylidene chloride may be used but will lower the oxygen barrier properties of the PVdC layer, as shown in FIG. 1. PVdC may also contain additives such as heat stabilizers, stearamide and plasticizing compounds such as epoxidized soybean oil as known in the art.

The central barrier layer may alternatively comprise PANMA-im (Barex®). Similar to PVdC, the oxygen barrier properties of PANMA-im is not dependent upon relative humidity. Thus, the oxygen transmission rate exhibited by PANMA-im remains almost the same at low relative humidity, for example 20%, as at high relative humidity, for example, 90%. Similar to EVOH, PANMA-im is a non-chlorinated polymer. PANMA-im may be of different grades, for example, grades Barex 210, Barex 214 and Barex 218, consisting of 10%, 14% and 18% rubber content, respectively and a density in the range of 1.13 to 1.15 glee.

The central barrier layer may alternatively comprise an aromatic nylon layer. This aromatic nylon layer may include aromatic nylons (also referred to as ‘polyamide’) and nylon-based nano-composites such as nylon 6, nylon 666, nylon 66, aromatic nylon (MDX6), nylon based nano-composites, nylon 11, nylon 12, nylon 4,6, nylon 6, 9 nylon 6,12, nylon terpolymer or a suitable blend of these nylons. Similar to EVOH, the oxygen barrier properties of a nylon layer are affected when exposed to relative humidity.

The central barrier layer may be a single layer selected from the above, multiple layers of the same central barrier layer, multiple layers of different oxygen barrier materials, or a combination of an oxygen barrier layer with a different polymer layer exhibiting another desired property, e.g. moisture resistance, and may be in the form of a micro-block, or nano-block layer arrangement. In one embodiment, the central barrier layer exhibits oxygen barrier properties and flexibility. For example, the central barrier layer may be a micro- or nano-block such as EVOH-tie-EVOH-tie, or PA-EVOH-tie-PA-EVOH-tie, or the like. The central barrier layer may comprise, for example, from 2 to 20 micro-layers. Using micro-layering rather than a single layer may also advantageously limit the potential decline in barrier properties if a single layer is subject to a pin hole or flex crack. Thus, the remaining micro-layers continue to exhibit barrier properties despite the decline in barrier properties experienced by a single damaged micro-layer. Alternatively, a micro-layer block of nylon-EVOH-tie-nylon-EVOH-tie may be provided. Advantageously, the nylon-EVOH layers are much thinner layers in a micro-block arrangement, and the tie layer provides a cushion to provide high flexibility and moisture barrier.

The first and second polymeric barrier layers surrounding the central barrier layer may either comprise a single layer or multiple layers in a micro-block or nano-block arrangement depending on the properties desired. The polymeric barrier layers may have a thickness in the range of from about 2 to about 50 microns, preferably between about 2 to about 25 microns, more preferably from about 2 to about 5 microns. Preferably, the polymeric barrier layers are symmetrical on either side of the central barrier layer to prevent or reduce curling of the resultant film.

The first and second polymeric barrier layers are selected from polymer layers providing at least one of moisture or gas barrier properties, or bulk, shrink or mechanical strength properties. The first and second polymeric barrier layers may incorporate one or more polymers that exhibit the same or different properties, and each of the first and second polymeric layer may incorporate polymers which are the same or different, e.g. the first polymeric layer may exhibit bulk properties while the second polymeric layer exhibits shrink properties.

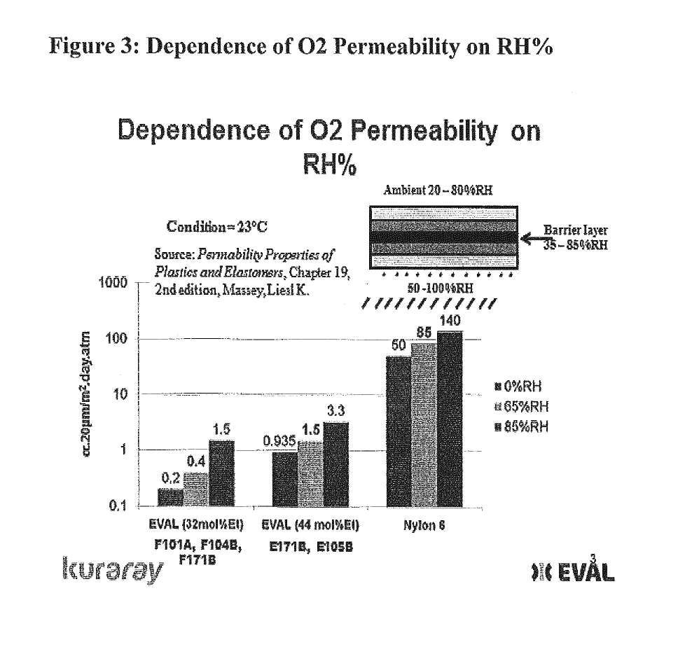

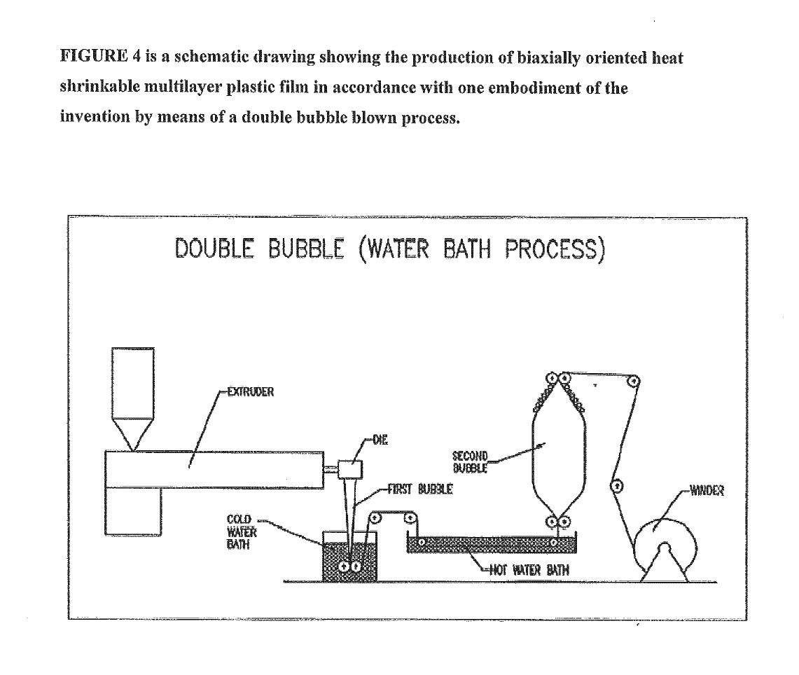

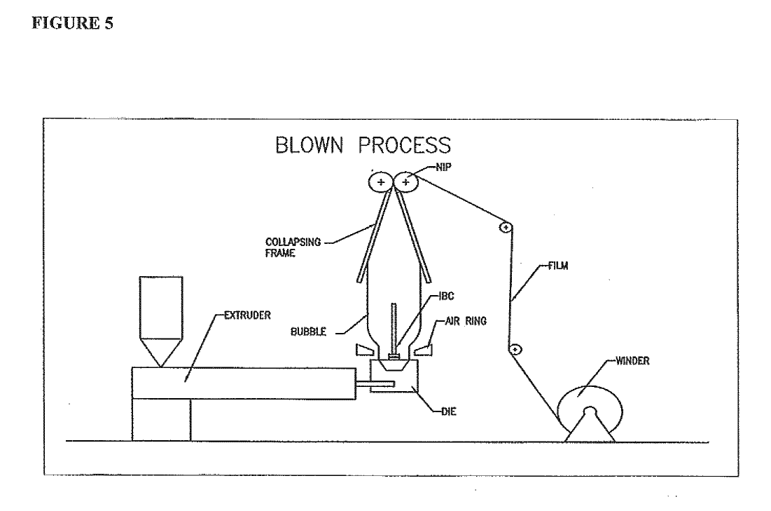

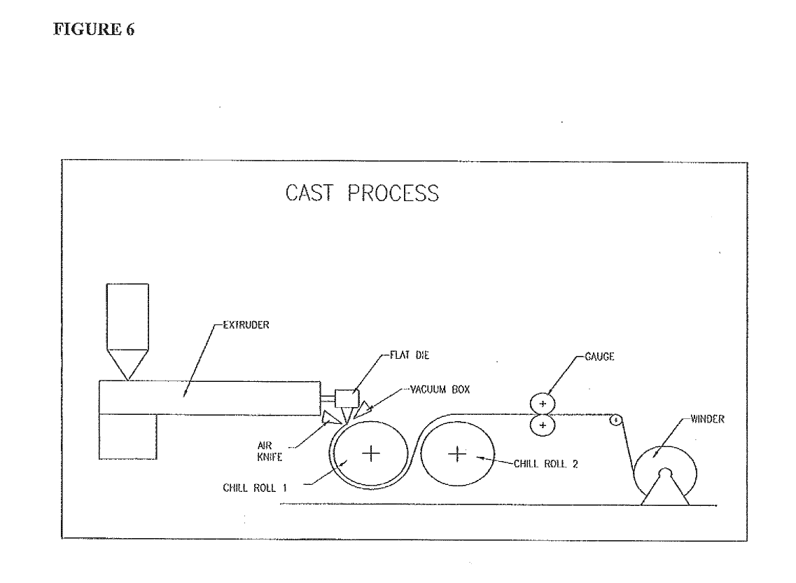

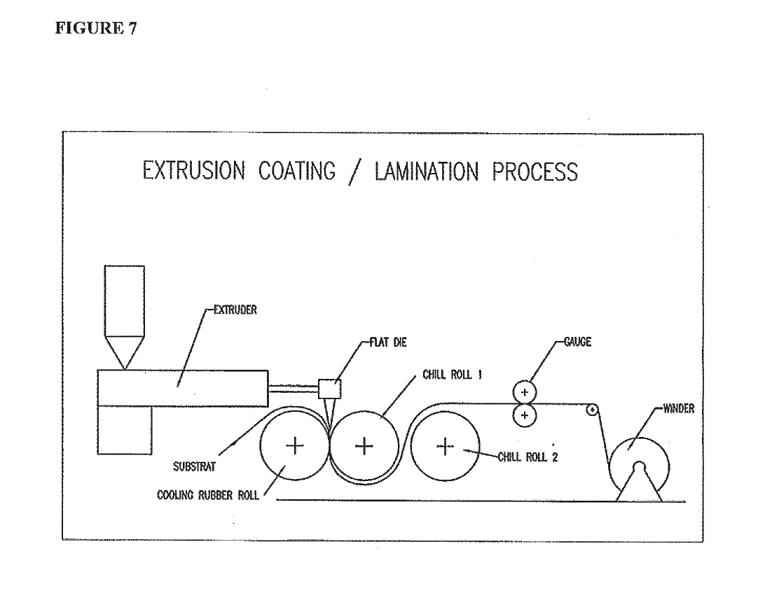

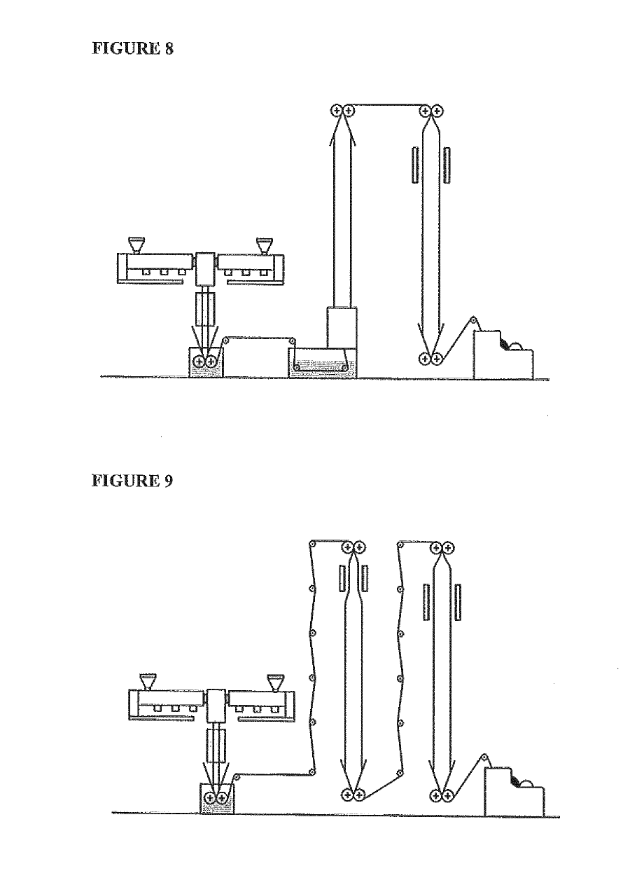

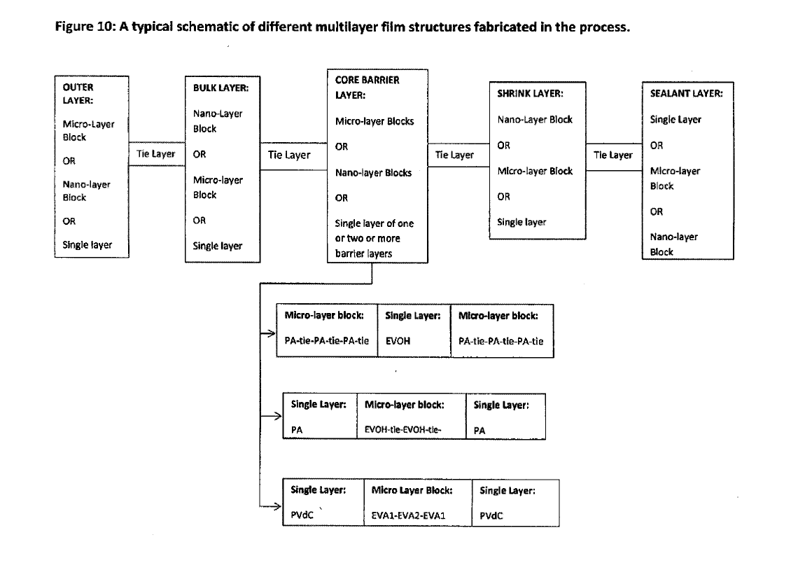

First, the first and/or second polymeric barrier layers may exhibit moisture barrier properties, e.g. water vapour permeability of less than about 2 g·mil/100 in 2 days @ 100° F. and 90% RH (see FIG. 3). Non-limiting examples of polymers which exhibit water vapour permeability within this range include polyvinylidene chloride (PVdC) and cyclic olefin copolymers (COC), polypropylene (PP) and polyethylene (PE). In one embodiment, when the central barrier layer is one that exhibits a decline in oxygen barrier properties when exposed to high relative humidity (RH), for example when the central barrier layer is EVOH, the first and second polymeric barrier layers may desirably be selected to exhibit moisture barrier properties. In this way, the EVOH layer is surrounded by first and second polymeric barrier layers which function to limit the permeation of moisture into the EVOH layer, preserving its oxygen and aroma barrier properties. Alternatively, the polymeric barrier layer may comprise a polymer(s) that does not exhibit a significant increase in oxygen permeability in the presence of moisture, and thus, functions to enhance the oxygen barrier properties of EVOH in the presence of moisture. Together, the central and polymeric barrier layers may provide a core that exhibits both moisture and oxygen barrier properties, which can be customized, to reach the desired moisture and oxygen barrier levels. This core may have a thickness of from about 3 to 45 microns, preferably from about 6 to 30 microns.

The first and/or second polymeric barrier layers may comprise one or more polymers exhibiting gas barrier properties, e.g. which exhibit oxygen permeability of less than about 0.9 cm-mil/100 in 2-24 hrs-atm when relative humidity is high, e.g., greater than about 85%. Examples of polymers within this group include Poly-acrylonitrile-methylacrylate copolymer (PANMA-im) and PVdC. The first and second polymeric barrier layers may contain additives to enhance their function as barrier layers. For example, the PVdC layers may contain additives such as heat stabilizers and plasticizing compounds such as epoxidized soybean oil and stearmide as known in the art. These polymers do not exhibit a significant decline in oxygen permeability properties in the presence of moisture, and thus, function to enhance the oxygen barrier properties of the central layer, such as EVOH, in the presence of moisture.

The first and/or second polymeric barrier layers may comprise one or more polymers that provide bulk. Examples of suitable bulk polymers include linear low density polyethylene (LLDPE), COC, very low density polyethylene (VLDPE), ethylene-vinyl acetate (EVA), ethylene methacrylate (EMA) and blends of plastomers or elastomers with polyethylene (PE). The bulk layer may be a single layer or may include layers of rigid and soft polymers in a micro- or nano-block. Rigid polymers include, for example, high density polyethylene (HDPE), medium density polyethylene (MDPE), polypropylene (PP) and COC, and soft polymers include LLDPE, EVA, EMA, ionomers, acid copolymers, plastomers and PE blends with elastomers. The bulk layer may alternatively comprise one or more polyolefins having a density of 0.88 g/cc to 1.04 g/cc, such as elastomers, plastomers, polypropylene homopolymer, copolymer, or terpolymer; styrene-based copolymers, polystyrene, styrene block copolymer (SBC), or a blend of low density polyethylene (LDPE), COC, PP, HDPE, LLDPE, metallocene LLDPE (mLLDPE), VLDPE, metallocene polyethylene (mPE), single site metallocene catalyst (SSC)-based LLDPE, EVA, EMA, blends of plastomers and elastomers with PE, and ionomers with a melt index (MI) of from about 0.5MI to 10MI, preferably from about 1.0MI to 6MI.

The first and/or second polymeric barrier layers may comprise one or more polymers that exhibit shrink properties. Examples of such polymers include EVA, EMA, terpolymer-pp, plastomers, elastomers and appropriate blends of these materials. The shrink layer may be a single layer, or a micro-block (preferably consisting of 4 to 10 layers) or nano-block (preferably consisting of 40 to 100 layers) of any suitable combination of EVA, EMA, ionomers, acid copolymers, VLDPE, LLDPE, plastomers, elastomers and blends thereof. Thus, the shrink layer may comprise polymers which modify shrink force, percentage shrink and which optionally provide other properties such as moisture barrier properties. The shrink layer may also comprise one or more polyolefins having a density of 0.88 g/cc to 0.920 g/cc, such as elastomers, plastomers, polypropylene copolymer, or terpolymer(pp) such as octene-LL, hexene-LL or butene-LL; or a blend of low density polyethylene (LDPE), linear low density polyethylene (LLDPE), metallocene LLDPE (mLLDPE), very low density polyethylene (VLDPE), metallocene polyethylene (mPE), high density polyethylene (HDPE), single site metallocene catalyst (SSC) based LLDPE, ethylene-vinyl acetate (EVA), ethylene methacrylate (EMA), Ethylene acrylic acid (EAA) and ionomers, with a melt index (MI) of from about 0.5MI to 10MI, preferably from about 1.6MI to 6 MI.

In one embodiment, the first and/or second polymeric layer is a bulk or shrink layer in the form of a nano-block (consisting of, for example, 40 to 90 or 100 nano-layers) of any two polymers such as from the polyolefin family or co- or terpolymers thereof, for example, octene-LL, hexene-LL, butene-LL, VLDPE, EVA. For example, the nano-block may comprise Octene-LL and Butene-LL. The bulk layer or shrink layer may optionally be irradiated after making the final film, or the bulk layer or shrink layer may be produced from irradiated resin to further improve mechanical properties.

In another embodiment, the first and/or second polymeric layer is a bulk or shrink layer in the form of a micro-block consisting of stiff hydrophobic and soft hydrophobic polymers. Stiff polymers may include LLDPE, HDPE, PP and COC, and soft polymers may be selected from plastomers, elastomers and blends of plastomers and/or elastomers.

Finally, the first and second polymeric barrier layers may comprise polymers that provide mechanical strength. Examples of such polymers may be, for example, Nylon, COC, Polyester, PS, HDPE and PP. These layers may be a single layer, or in a micro-block (for example, from about 2 to about 40 layers) or nano-block (for example, from about 40 to about 100 layers) arrangement.

The outer polymeric layer is adjacent to the first polymeric barrier layer, and functions as the exterior layer of the multi-layer film or sheet, i.e. the layer of the film that is exposed to the ambient or outside environment. Thus, this outer layer may provide mechanical strength, tensile strength, heat resistance, abuse resistance, gloss, and/or printability to the multi-layer film. Suitable polymers for use in this layer include polyolefins (PO), polyamides (PA), and polyesters. Examples include, but are not limited to, thermoplastic polymers such as polyesters, e.g. polyethylene terephthalate (PET), e.g. PET with a melting point of above 250° C., polyethylene terephthalate glycol-modified (PETG), PP, amorphous polyethylene terpthalate (APET), Polyethylene naphthalate (PEN) and Polybutylene terephthalate (PBT), PLA (Poly lactic acid); COC, or polyolefin, blends of COC with PE or PP (homopolymer or copolymers), nylons (polyamide polymers) such as nylon-6,6 e.g., with a melting point of about 250° C.; nylon-6 e.g., with a melting point of about 220° C.; a blend of nylon-6 with nylon-6,6; a blend of nylon-6 with nylon-6,12; nylon 6/66 copolymer e.g., with a melting point of about 185° C. to about 195° C.; nylon 6,12, nylon terpolymer; Nylon 11 Nylon 12, Nylon 6,9, Nylon 4,6, aromatic nylon (MDX6). Appropriate polymers may have an inherent viscosity (IV) in the range of 3.2 to 4.7 (96% sulfuric acid, 1 g/100 ml), as specified by suppliers and a melting point from about 190° C. to 265° C. Other examples include: PA, HDPE, PS, LLDPE etc. The outer polymeric layer may have a thickness in the range of from about 1.5 to about 9 microns, preferably from about 2 to about 5 microns. The outer layer may be a single layer, microblock or nanoblock.

The abuse resistance, toughness, and puncture resistance may be increased in the outer layer by forming the outer layer with co-extruded polyamides, such as nylon 6, nylon 6/66, nylon 4,6, or blends of nylon 66 with nylon 6, or any other appropriate blends of nylons (nylon 6-12, nylon 11, nylon 12).

The outer layer may incorporate polymers that exhibit bulk or shrink properties. In one embodiment, the outer layer polymer(s) are combined with one or more bulk or shrink layer polymers via a tie layer, e.g. to form a micro- or nano-block.

The sealant layer is adjacent to the second polymeric barrier layer, and functions as the interior layer of the multi-layer film, i.e. the layer that is adjacent to the product being packaged or enrobed by the multi-layer film. The sealant layer may comprise one or more polymers selected from polyolefins, ionomers, and acrylates. Examples of polymers suitable for inclusion in the sealant layer include PE, PO resins (C4, C6, C8), LDPE, LLDPE, mLLDPE, SSC-based LLDPE, MDPE, mPE, plastomers, elastomers, blends thereof, blends of LLDPE with plastomers, ethylene acrylic acid copolymer (EAA), EMA, ethylene acrylic acid, ethylene methacrylic acid, salts of ethylene acrylic acid or methacrylic acid, ethylene-vinyl acetate (EVA), ethylene methyl acrylate copolymer (EMAC), ionomers, acid copolymers, and PP homopolymers, copolymers, and terpolymers. In one embodiment, the sealant layer may comprise LLDPE with a melt index of from about 0.5 to about 6.0 decigram per minute. The sealant layer may have a thickness in the range of from about 10 to about 40 microns preferably from about 15 to about 25 microns. While the sealant layer may be a single layer or micro- or nano-block, a single layer arrangement is preferred.

### Micro-Blocks and Nano-Blocks

The following provides exemplary micro- or nano-blocks for use in the present multi-layer film or sheet.

### Micro- or Nano-Block for Outer Layer:

To achieve the properties of high mechanical strength and moisture resistance, the outer layer may comprise a micro- or nano-block of two polymers such as a ‘high mechanical strength-hydrophilic polymer’ and a ‘moisture barrier-hydrophobic polymer’. For example, the a micro-block may comprise, 2 layers of PA which is hydrophilic and provides high mechanical strength, and 2 layers of Tie, selected to be a moisture barrier-hydrophobic polymer, e.g. maleic anhydride modified LLDPE, LDPE or EVA, to form a block such as PA/tie/PA/tie. The outer layer may include multiple alternating layers, for example, 10 micro-layers: PA/tie/PA/tie/PA/tie/PA/tie/PA/tie/PA. This micro-block may be represented as (high mechanical strength-hydrophilic polymer/soft moisture barrier polymer) and is useful for the improvement of mechanical properties, for example, preventing flex cracking and improving flexibility and thermo-formability. Additional examples of micro- or nano-blocks having these properties include: (PA-Tie)ₙ, (PET-Tie)ₙ, (MXD6-Tie)ₙ, (PA1-PA2-Tie)ₙ.

### Micro- or Nano-Block for Central Barrier Layer:

To achieve the properties of oxygen and moisture barrier, the central barrier layer may comprise a micro- or nano-block of polymers which are ‘oxygen barrier (hydrophilic or hydrophobic) rigid polymer’ and ‘moisture barrier soft polymer’, for example, EVOH/tie/EVOH/tie. In this instance, since EVOH is an oxygen barrier exhibiting a decline in oxygen barrier properties in the presence of high RH, the tie layer is moisture barrier such as maleic anhydride modified LLDPE, LDPE or EVA. The tie layer may be blended with other PO materials. Another example of this series is EVOH-PA-tie/EVOH-PA-tie/EVOH-PA-tie. In this case, EVOH and PA are two thin layers and the tie layer provides a cushion or moisture barrier layer. Another example of a micro- or nano-block for the central barrier layer is one including polymers which provide rigid-oxygen barrier and soft moisture barrier, such as (PA-Tie)ₙ, (EVOH-Tie)ₙ, (EVOH-PA-Tie)ₙ, (Barex®-Tie)ₙ, (PVdC-tie)ₙ, (MXD6-Tie)ₙ, (EVOH1-EVOH2-Tie)ₙ, and (PA1-PA2-Tie)ₙ.

### Micro- or Nano-Block for Bulk and Shrink First and Second Polymeric Layers:

A micro- or nano-block may be used for the first or second polymeric layers. For bulk or shrink layers as the first or second polymeric layers of the film, a rigid or soft polymer alternating with a soft, shrink polymer may be used comprising, for example, 20 layers to 100 layers. Examples of rigid polymers include, HDPE, PP or COC; examples of soft polymers include, LLDPE(O), LLDPE(h), LLDPE(B), and VLDPE; and examples of shrink polymers include, EVA and mPE. Such a block may improve tear, shrink and impact resistance of the multilayer film. This block may be represented as (rigid-polymer/soft polymer). Examples include (COC-mPE)ₙ, (HDPE-mPE)ₙ, (PP-mPE)ₙ, (LLDPE(O)-LLDPE(B))ₙ, and (EVA-mPE)ₙ.

Exemplary films in accordance with embodiments of the invention are described in the following.

### EVOH in Film

A novel multilayer plastic film is provided comprising a series of component layers and bonding layers to tie said component layers together, said component layers comprising: a hydrolyzed ethylene vinyl acetate copolymer (EVOH) central oxygen barrier layer, a first polymeric barrier layer comprising a block of micro-layers such as PA₁-tie₁-PA₂-tie₂-PA₃-tie₃ on a first side of the EVOH layer and a second polymeric barrier layer comprising a second block of micro-layers such as PA′₁-tie′₁-PA′₂-tie′₂-PA′₃-tie′₃ on a second side of the EVOH layer. The two micro-blocks on either side of EVOH may be the same or different to exhibit different properties such as different flow, different barrier or mechanical properties. The micro-blocks are bonded to the central barrier layer EVOH by tie₃ and tie′₃. The micro-block may include from two to five different polymers. For example, the micro-block may be Nylon (PA) and a tie resin. The Nylon resin may be Nylon6, Nylon6,6/6, Nylon 6, 9, Nylon 66, aromatic nylon, nylon-based nano composites, Nylon 11, Nylon 12, Nylon 6,12, Nylon 4,6 terpolymer nylon or suitable blends of any of two nylons. Tie resins may be based on maleic anhydride-grafted PE resins such as EVA, EMA, LDPE or LLDPE or acid copolymer. The tie resin could be blended with PP, HDPE, COG or LLDPE.

A film structure incorporating a central EVOH barrier and PA-tie micro-blocks as first and second polymeric layers may be as follows: Outer layer (PETG, PA or PP)/tie/bulk layer/tie/PA1-tie1-PA2-tie2/EVOH/tie2-Pa2-tie1-Pa1/tie/shrink layer/Sealant layer. This film structure has 7 main layers and 2 micro-blocks (underlined in the above structure) of 4 micro-layers, and the above structure has a total of 15 layers. The total number of layers may be more or less, depending on the number of layers in the micro-blocks. This film provides improved properties. Since EVOH oxygen barrier properties are dependent on relative humidity, the outer layer, tie layer, and bulk layer will provide some moisture barrier properties from the outside environment based on the materials selected for these layers. Additionally, the sealant, shrink and tie layers may provide moisture barrier properties from the inside environment. Accordingly, the first polymeric barrier layer (bulk layer) is a micro-block facing the ambient or outer environment, and the second polymeric barrier layer (shrink layer) is a micro-block facing inner environment. Thus, in a high relative humidity environment (e.g., 90% or higher), based on the WVTR of polymers selected for the outer layers/tie/bulk layer, some of the moisture molecules will permeate and interact with PA1, and similarly based on the WVTR of polymers selected for the inner layer, some of the moisture molecules will permeate through the sealant layer, shrink layer and tie layer and will interact with the PA1′ layer. However, in this micro-block arrangement, not all micro-layers of the micro-block will be affected; rather, those closest to the exposure may be affected. This is because while the PA1 and PA1′ micro-layers absorb moisture that permeates to these layers, additional PA micro-layers exist interfaced with hydrophobic tie layers (tie1, tie2, . . . or tie1′ tie2′ . . . ). Thus, the permeation of moisture through the layers is slowed and improves the mechanical properties of the film providing a longer shelf-life for the product enrobed in the final film. If sufficient moisture is absorbed to saturate the first layer of PA1 or PA1′, the moisture will then face the hydrophobic interface layer of Tie1 or Tie1′, followed by the next layer of PA2 and PA2′ and so on. These hydrophobic interfaces hinder the permeation of moisture molecules and protect the central EVOH layer, thus providing improved oxygen barrier properties, as well as moisture barrier and mechanical properties.

It is also noted that, in the above film structure, the micro-block on either side of the EVOH layer, comprises PA1-tie1-PA2-tie2. PA is a high mechanical strength-hydrophilic polymer and the tie layer is the soft-hydrophobic polymer. The soft tie layer in between stiff PA layers provides a cushioning effect in the primary tube (double bubble with annealing film) leading to a more flexible primary tube which is less prone to flex cracking of barrier layers (as compared to prior films in which Nylon/EVOH or Nylon/EVOH/nylon are coextruded in a primary tube as one combined block and exhibit a higher risk of flex crack). In this structure, the PA-Tie micro-block may include, for example, 2 to 5 micro-layers each, (e.g. (PA1ₙ (n=2 to 5), Tie1ₙ (n=2 to 5)), and these PA and Tie micro-layers may be of different thicknesses and of different nylons and tie resin blends for providing a desired flexibility to the primary tube.

In a further example, the central layer may be comprised of a micro-block including different EVOH grades, such as: EVOH32₁-EVOH48₁-tie-EVOH32₂-EVOH48₂-tie-EVOH32₃-EVOH48₃. Other EVOH grades may also be used (e.g., ethylene content 25 mole % to 48 mole % with over 98% of saponification values) with appropriate tie layers.

### Barex® in Film

In another embodiment, a multilayer plastic film is provided comprising a series of component layers and bonding layers to tie said component layers together, said component layers comprising: as a central oxygen barrier layer, impact modified acrylonitrile-methyl acrylate copolymer, referred as PANMA-im (Barex®), a first micro-block such as PA₁-tie₁-PA₂-tie₂-PA₃-tie₃ on a first side of the PANMA-im layer and a second micro-block such as PA′₁-tie′₁-PA₂-tie′₂-PA′₃-tie′₃ on a second side of the Barex® layer. The micro-blocks are bonded to PANMA-im by tie₃ and tie′₃, and the micro-blocks are comprised of two polymers such as Nylon (PA) and tie resin. The Nylon resin may be Nylon6, Nylon6,6/6, aromatic nylon or nylon-based nano composites, Nylon 11, Nylon 12, Nylon 6,12, Nylon 4,6 terpolymer nylon or suitable blends of any of two nylons. The tie resins may be EVA, EMA, LDPE or LLDPE based maleic anhydride, Acid copolymer or tie resin blended with PP, HDPE, COC or LLDPE. The film structure may additionally comprise a first polymeric layer such as a bulk layer, e.g. a single layer of LLDPE, VLDPE, EVA, EMA, or blends of plastomers or elastomers with PE or other polymers; a second polymeric layer such as a shrink layer based on EVA, EMA, plastomers, elastomers or appropriate blends of these materials; as well as outer and sealant layers, e.g. Outer layer (PETG, PA, PP, COC)/tie/bulk layer/tie/PA1-tie1-PA2-tie2-PA3-tie3/PANMA-im(Barex)/tie3-PA3′-tie2-PA2′-tie1-pA1′/tie/shrink/sealant layer.

In this structure, Barex® is used as an oxygen barrier material with a micro-block of PA/tie. Oxygen transmission rate of Barex remains generally independent of RH. Accordingly, the resultant film will have significantly less varying oxygen transmission rate which change in relative humidity, as long as other parameters such as temperature and handling do not change significantly.

In another embodiment, a film is made by co-extruding EVOH and Barex® as the central oxygen barrier layers with microblocks, such as: Outer layer (PETG, PA, PP or COC)/tie/bulk layer/tie/PA1-tie1-PA2-tie2-PA3-tie3/tie/Barex/tie/EVOH/tie3-PA3′-tie2-PA2′-tie1-pA1′/tie/shrink/sealant layer. This film structure may be useful in environments where the RH varies. For example, a multilayer film may be exposed to different environments and ambient conditions such as a manufacturer's warehouse or during transportation over a varying period of time to a meat or food packaging company. Once delivered, the film may be packaged with a food product such as meat or cheese that provides a high RH level inside and may be shrunk in a water bath at, for example, 90° C., before being transported and finally placed for retail. During these steps, little control is available over RH or ambient conditions to which this multilayer film is exposed. Additionally, many biaxial shrink films are relatively thin (30 to 90 microns). Thus, EVOH provides an excellent oxygen barrier at low RH, the combination with Barex® provides a more consistent oxygen transmission rate at increased RH (above 90%, for example). The co-extrusion of Barex® and EVOH has applications for food, medical, and industrial packaging sectors. It is noted that a lower ethylene content leads to a higher OH content, and a higher barrier to oxygen at low RH. However, this barrier declines with increasing RH. Thus, Barex® provides additional oxygen barrier properties.

In another example of Barex® in a film, a film structure may be: Outer layer(PETG, COC, PA, or PP)/tie/bulk layer/tie/PA1-tie1-PA2-tie2-PA3-tie3/tie/PANMA-im/tie/HDPE-PE blend/tie3-PA3′-tie2-PA2′-tie1-pA1′/tie/shrink/sealant layer. In this instance, Barex® within the central layer provides oxygen barrier properties, while the HDPE-PE blend provides high moisture barrier properties. Alternatively, the HDPE-PE blend may be substituted with PP, COC or PVdC as a moisture barrier layer within the central layer in the above structure.

### PVdC in Film:

In another embodiment, the central barrier layer may be Poly (vinylidene chloride with methyl methacrylate) (PVdC) to provide the oxygen barrier properties. Thus, a multilayer plastic film is provided comprising a series of component layers and bonding layers to tie said component layers together, said component layers comprising: PVdC as the central oxygen barrier layer; EVA (va 25 to 28 wt %) is used as the bonding layer to PVdC, a first micro-block such as PA1-tie1-PA2-tie2-PA3-tie3 is on a first side of the PVdC layer and a second micro-block such as PA′1-tie′l-PA2-tie′2-PA′3-tie′3 is on a second side of the PVdC layer. The micro-blocks are bonded to EVA by tie3 and tie3, and the micro-block is comprised of two polymers such as Nylon (PA) and tie resin. In this case, the selected Nylon resin preferably has a melting point of below 195° C. (due to the thermal sensitive nature of PVdC), e.g. Nylon 6,6/6, Nylon 6,12 or terpolymer nylon or suitable blends with amorphous nylon. The tie resins may be maleic anhydride-grafted PE resins based on EVA, EMA, LDPE or LLDPE, acid copolymer. The tie resin may be blended with PP, HDPE, COC or LLDPE. The film structures may have other layers such as a bulk layer which may be a single layer of LLDPE, VLDPE, EVA, EMA, blends of plastomers or PE blends with elastomers; and a shrink layer based on EVA, EMA, plastomers, elastomers or appropriate blends of these materials; as well as outer and sealant layers as previously described.

In this proposed film structure, PVdC serves as the central barrier layer. Thus, a film structure may be: Outer layer (PETG, PP, PA, or COC)/tie/bulk layers/tie/PA1-tie1-PA2-tie2-PA3-tie3/PVdC/tie3-PA3′-tie2-PA2′-tie1-pA1′/tie/sealant layer. In this structure, the PVdC copolymer, in combination with PA-tie microblocks, is used as high oxygen barrier layer (FIGS. 1 and 2). In addition to oxygen barrier properties, PVdC has high moisture barrier properties. Thus, the micro-block of PA1-Tie1-PA2-Tie2 is effective to protect PA as explained above and in an environment of high RH, PVdC moisture barrier properties will also block moisture molecules from permeating through the complete structure thus providing both high oxygen and moisture barrier properties, as well as maintaining high mechanical properties.

An alternative structure using PVdC as the central oxygen barrier is as follows: Outer layer(PETG, PA, PP or COC)/tie/PVdC/tie/bulk layer/tie/PA1-tie1-PA2-tie2-PA3-tie3/PVdC/tie/shrink/sealant side. In this structure, PVdC and a single microblock is the central oxygen barrier layer having both oxygen barrier and moisture barrier properties. It is used for additional moisture protection of PA in the micro-block given that tie or blends of tie with HDPE, PP or COC are used for protecting PA in the contemplated film structures. In this case, the moisture protection of PA occurs from both the outside and inside environment. Hence, the PA will be exposed to much less moisture resulting in the maintenance of low RH at the nylon interface and contributing to improved mechanical properties. In this structure Nylon copolymer or terpolymer of lower melting is contemplated. PVdC is a very high moisture barrier, much higher than PE, PP, tie and even better than COC (see FIG. 1). Depending on the application, a film may comprise PVdC on one side or both sides of a central oxygen barrier layer.

An alternative structure for a biaxial film using PVdC is as follows: Outer layer (PETG, PA, PP, COC, HDPE)/tie/bulk-layer/tie/PVdC/tie/PA1-tie1-PA2-tie2-PA3-tie3/EVOH/tie3-PA3′-tie2-PA2′-tie1-pA1′/tie/PVdC/tie/shrink/sealant side. Here, the central barrier layer comprises EVOH as an oxygen barrier, the PA layers are used for their mechanical properties and both are protected by PVdC copolymer. The PVdC copolymer as mentioned provides a moisture barrier leading to a lower RH at the EVOH and Nylon interface (as compared to the use of PE of the same thickness as moisture barrier) resulting in better oxygen, moisture and mechanical properties. As above, depending upon the application, PVdC can be used on either side of a central barrier.

In all the above examples, several combinations of micro- or nano-layers for the first and second polymeric layers as bulk and shrink layers is possible using a rigid hydrophobic polymer/soft hydrophobic polymer to improve the mechanical properties of the film, for example, tear and impact. Micro- and nano-blocks may be used where PETG, PP, COC, HDPE and EVOH are used in the outer, bulk, central and shrink layers. Since these materials are very rigid and have a tendency to flex crack specifically in the primary tube (or thick sheet as cast or blown sheet), micro- and/or nano-blocks incorporating soft materials provide greater flex. For example, micro-blocks of PETG/Tie such as PETG1-Tie1-PETG2-Tie2-PETG3-Tie3, may be used in an outer layer, such as: (Outer layer) PETG1-tie1-PETG2-tie2/bulk layer/tie/(PA₁-tie₁-PA₂-tie₂-PA₃-tie₃)/EVOH/tie/Sealant layer. In order to inhibit flex crack while maintaining the barrier properties of PA, the PA-tie microblock may be replaced with a micro-block such as PA6₁-PA666₁-Tie-PA6₂-PA666₂-Tie-PA6₃-PA666₃. PA6 is a rigid material and has high mechanical properties with melting point of about 220° C.; however, PA666 is a copolymer (with a melting point of 195° C.). Thus, rather than using a single layer of PA in core of either PA6 or PA666 or a blend, micro-layers of Nylon 6 and Nylon 666 can be used while the tie layer provides a cushion and moisture barrier resulting in materials with less flex crack. A micro-block such as PA6₁-PA612₁-tie-PA6₂-PA612₂-tie-PA6₃-PA612₃ or PA666₁-PA612₁-tie-PA666₂-PA612₂-tie-PA666₃-PA612₃ may also be used. Similarly, a micro-block of PA/tie using Nylon 11, Nylon 12, Nylon 4,6, Nylon 66, aromatic or nylon-based nano-composite may be used.

In these film structures, the design of the die mandrel (which gives the micro-layers) is such that one can adjust the amount (or percentage) of the PA layer equally divided as PA₁, PA₂, and PA₃ or % of Tie layer equally divided as Tie₁, Tie₂ and Tie₃. The percentage of each micro-layer for Polymer A can also be adjusted, for example, the percentage of PA₁ micro-layer can be higher than the percentage of micro-layer PA₂ and PA₃, which means the thickness of PA₁ could be more then PA₂ and PA₃. A higher percentage of one of the micro-layers (PA₁) may be is desirable as compared to the other micro-layers (PA₂ and PA₃), when one of the micro-layers is the core contact layer towards a high humidity side. This adjustment can be done for any layer, e.g. Tie₁, Tie₂ and Tie₃. As well, a higher or lower number of micro-layers can be fabricated depending upon the utility of the film. Using a die mandrel alone (in a multilayer die), one can make at least 2 micro-layers and up to 20 micro-layers from each polymer A and Polymer B yielding at least 4 micro-layers: PA₁-tie₁-PA₂-Tie₂ and up to 40 micro-layers, although structures with more micro-layers can be fabricated.

Combination of Central Barrier Layers with Micro- or Nano-Blocks

The central oxygen barrier layer may also be a combination of barrier layers, for example, Barex® and EVOH tied with a tie layer. A first micro-block such as PA₁-tie₁-PA₂-tie₂-PA₃-tie₃ is on a first side of the central oxygen barrier layer (Barex®/Tie/EVOH) and a second micro-block such as PA′₁-tie′₁-PA₂-tie′₂-PA′₃-tie′₁ is on a second side of the central oxygen barrier layer. The micro-block is bonded to central oxygen barrier layer by tie₃ and tie′₃, and the micro-block is comprised of at least two polymers such as Nylon (PA) and tie resin. The Nylon resin could be Nylon6, Nylon6,6/6, Nylon 66, aromatic nylon, nylon based nano-composites, Nylon 6,9, Nylon 11, Nylon 12, Nylon 6,12, Nylon 4,6 terpolymer nylon or suitable blends of any of two nylons. The tie resins could be maleic anhydride grafted PE resins such as EVA, EMA, LDPE or LLDPE, acid copolymer. The tie resin is blended with PP, HDPE, COC or LLDPE.

In another embodiment, the central oxygen barrier comprises two high oxygen barrier layers such as PANMA-im (Barex) and PVdC. Here, PVdC is used as moisture barrier layer and bonded with EVA on both sides, a tie layer is used to bond PANMA-im with EVA/PVdC, so the core high oxygen barrier layer configuration is, ‘Tie/PANMA-im/Tie/EVA/PVdC/EVA’. A first micro-block such as PA₁-tie₁-PA₂-tie₂-PA₃-tie₃ is on one side of the central barrier layer and a second micro-block such as PA′₁-tie′₁-PA₂-tie′₂-PA′₃-tie′₃ is on a second side of the core barrier layer. The micro-block is comprised of two polymers such as Nylon (PA) and tie resin. In this case, the Nylon resin will preferably have a melting point of below 190° C., e.g. Nylon 6,66, Nylon 6,12 or terpolymer nylon or suitable blends with amorphous nylon. Tie resins may be maleic anhydride-grafted PE resins such as, EVA, EMA, LDPE or LLDPE, acid copolymer. The tie resin could be blended with PP, HDPE, COC or LLDPE. The film structure may have other layers such as a bulk layer, and/or a shrink layer which could be a single layer of LLDPE, VLDPE, EVA, EMA, plastomers, elastomers, blends of plastomers or elastomers with PE, or other blends, as well as an outer layer and a sealant layer. The outer layer may comprise heat and abuse resistance layers of PETG, PA, PP, HDPE, COC, LLDPE etc. The sealant layer may consist of blends of LLDPE with EVA, LDPE, mPE, mLLDPE, ionomers, acid copolymers, plastomers and elastomers.

### Method

A multi-layer film in accordance with the present invention may be made using various established methods. These methods include the use of an annular co-extrusion die such as in double bubble, double bubble with third bubble for annealing, and blown process (air cooled and water cooled), and flat co-extrusion dies such as cast process, sheet process, and extrusion coating process, blow molding. The multi-layer film produced can be laminated on different surfaces (for example, BOPET, BOPP, BOPA & printed films) or PVC, PP or APET sheet by solvent, solventless and water-based lamination processes to convert the multi-layer film into bags, pouches, or stand-alone webs. The multilayer film may also be used to produce containers, bottles and the like by extrusion blow molding or injection stretch blow moulding process.

The present multi-layer film may also be made by extruding multilayer plastic material in tubular bubble form to provide a multilayer plastic film having a series of component layers and bonding layers tying the component layers together, where the component layers include the inner EVOH layer surrounded by the first micro-layer block and the second micro layer block, with bulk layer and bulk layer bonding to the outer layer, and the sealant layer adjacent the shrink layer and shrink layer adjacent to second micro-layer block, and cooling and collapsing the tubular film to sheet form.

The present multi-layer film may also be made by subsequently returning the collapsed plastic tube to a second tubular bubble form, stretching the second tubular bubble radially and longitudinally to produce a biaxially oriented heat shrinkable film, and collapsing the second tubular bubble to a further sheet form. The further sheet form may be partially cross-linked by exposure to high energy electrical radiation to improve the mechanical properties of the film,

The present multi-layer film may also be made by extruding multi layer plastic film in cast form to provide a multilayer plastic film having a series of component layers and bonding layers tying said component layers together, and cooling the film. The multilayer plastic film may be laminated to a web before cooling.

The above-described multi-layer film may also be blow molded to form containers or bottles.

Embodiments of the invention are described in the following specific examples which are not to be construed as limiting.

### Example 1: Structural Film Examples

Examples of multilayer films in accordance with the present invention include films having multiple layers, e.g. from 9 to 150 layers. The reference to “tie” refers to a bonding layer.

Example for Multilayer Bi-Ax Film with PANMA-im, EVOH and PVdC as Barrier Layers with Micro-Layer Block of PA/Tie and Single Layer for Bulk and Shrink Layer (16-28 Layers)

PETG/tie/bulk-layer/tie/(PA1-tie1-PA2-tie2)/EVOH/(tie2-PA2-tie1-PA1)/tie/shrink layer/Sealant layer.

PETG/tie/bulk-layer/tie/(PA1-tie1-PA2-tie2-PA3-tie3-PA4-tie4-PA5-tie5-PA6-tie6-)/EVOH/tie/(PA1-tie1-PA2-tie2-PA3-tie3-PA4-tie4-PA5-tie5-PA6-tie6-)tie/shrink layer/Sealant layer.

PA/tie/bulk-layer/tie/(PA1-tie1-PA2-tie2)/EVOH/(tie2-PA2-tie1-PA1)/tie/shrink layer/Sealant layer.

PP/tie/bulk-layer/tie/(PA1-tie1-PA2-tie2)/EVOH/(tie2-PA2-tie1-PA1)/tie/shrink layer/Sealant layer.

LLDPE/tie/bulk-layer/tie/(PA1-tie1-PA2-tie2)/EVOH/(tie2-PA2-tie1-PA1)/tie/shrink layer/Sealant layer.

COC/PE/bulk-layer/tie/(PA1-tie1-PA2-tie2)/EVOH/(tie2-PA2-tie1-PA1)/tie/shrink layer/Sealant layer.

LLDPE/PE/bulk-layer/tie/(PA1-tie1-PA2-tie2)/EVOH/(tie2-PA2-tie1-PA1)/tie/shrink layer/Sealant layer.

PETG/tie/bulk-layer/tie/(PA1-tie1-PA2-tie2)/PANMA-im(barex)/(tie2-PA2-tie1-PA1) tie layer/shrink layer/Sealant layer.

PA/tie/bulk-layer/tie/(PA1-tie1-PA2-tie2)/PANMA-im(barex)/(tie2-PA2-tie1-PA1) tie layer/shrink layer/Sealant layer.

PETG/tie/bulk-layer/tie/(PA1-tie1-PA2-tie2)/tie/PANMA-im(barex)/tie/EVOH/(tie2-PA2-tie1-PA1)/tie/shrink layer/Sealant layer.

PETG/tie/bulk-layer/tie/(PA1-tie1-PA2-tie2)/EVA/PVdC/EVA/tie2-PA2-tie1-PA1/tie/shrink layer(s)/Sealant layer. PA, PP, PS, COC as other outer layers.

PETG/tie/bulk-layer/tie/(PA1-tie1-PA2-tie2)/tie/PANMA-im(barex)/EVA/PVdC/EVA/tie2-PA2-tie1-PA1/tie/shrink layer/Sealant layer. PA, PP, PS, COC as other outer layers.

Example for Multilayer Bi-Ax Film with PANMA-im, EVOH and PVdC as Barrier Layers with Micro-Layer Block of PA/Tie and Micro-Layers for Bulk and Shrink Layer Up to 100 Layers

PETG/tie/micro bulk-layer/tie/(PA1-tie1-PA2-tie2-PA3-tie3)/EVOH/tie3-PA3-tie2-PA2-tie1-PA1/tie/micro shrink-layer/Sealant layer.

PA/tie/micro bulk-layer/tie/(PA1-tie1-PA2-tie2-PA3-tie3)/EVOH-tie-EVOH-tie/tie3-PA3-tie2-PA2-tie1-PA1/tie/micro shrink-layer/Sealant layer.

PP/tie/micro bulk-layer/tie/(PA1-tie1-PA2-tie2-PA3-tie3)/PA1-EVOH1-tie1-PA2-EVOH2-tie3/tie3-PA3-tie2-PA2-tie1-PA1/tie/micro shrink-layer/Sealant layer.

COC/tie/micro bulk-layer/tie/(PA1-tie1-PA2-tie2-PA3-tie3)/EVOH/tie3-PA3-tie2-PA2-tie1-PA1/tie/micro shrink-layer/Sealant layer.

PS/tie/micro bulk-layer/tie/(PA1-tie1-PA2-tie2-PA3-tie3)/EVOH/tie3-PA3-tie2-PA2-tie1-PA1/tie/micro shrink-layer/Sealant layer.

LLDPE/PE/micro bulk-layer/tie/(PA1-tie1-PA2-tie2-PA3-tie3)/EVOH/tie3-PA3-tie2-PA2-tie1-PA1/tie/micro shrink-layer/Sealant layer.

PETG/tie/micro bulk-layer/tie/(PA1-tie1-PA2-tie2-PA3-tie3)/PANMA-im/tie3-PA3-tie2-PA2-tie1-PA1/tie/micro shrink-layer/Sealant layer.

PA/tie/micro bulk-layer/tie/(PA1-tie1-PA2-tie2-PA3-tie3)/PANMA-im/tie3-PA3-tie2-PA2-tie1-PA1/tie/micro shrink-layer/Sealant layer.

PETG/tie/micro bulk-layer/tie/(PA1-tie1-PA2-tie2-PA3-tie3)/EVA/PVdC/EVA/tie3-PA3-tie2-PA2-tie1-PA1/tie/micro shrink-layer/Sealant layer.

Example for Multilayer Bi-Ax Film with PANMA-im, EVOH and PVdC as Barrier Layers with Micro-Layer Block of PA/Tie and Nano-Layers for Bulk and Shrink Layer (Up to 150 Layers)

PETG/tie/nano bulk-layer/tie/(PA1-tie1-PA2-tie2-PA3-tie3)/EVOH/tie3-PA3-tie2-PA2-tie1-PA1/tie/nano shrink-layer/Sealant layer.

PA/tie/nano bulk-layer/tie/(PA1-tie1-PA2-tie2-PA3-tie3)/EVOH/tie3-PA3-tie2-PA2-tie1-PA1/tie/nano shrink-layer/Sealant layer.

PP/tie/nano bulk-layer/tie/(PA1-tie1-PA2-tie2-PA3-tie3)/EVOH1 tie3-PA3-tie2-PA2-tie1-PA1/tie/nano shrink-layer/Sealant layer.

COC/tie/nano bulk-layer/tie/(PA1-tie1-PA2-tie2-PA3-tie3)/EVOH/tie3-PA3-tie2-PA2-tie1-PA1/tie/nano shrink-layer/Sealant layer.

PS/tie/nano bulk-layer/tie/(PA1-tie1-PA2-tie2-PA3-tie3)/EVOH/tie3-PA3-tie2-PA2-tie1-PA1/tie/nano shrink-layer/Sealant layer.

LLDPE/PE/nano bulk-layer/tie/(PA1-tie1-PA2-tie2-PA3-tie3)/EVOH/tie3-PA3-tie2-PA2-tie1-PA1/tie/nano shrink-layer/Sealant layer.

PETG/tie/micro bulk-layer/tie/(PA1-tie1-PA2-tie2-PA3-tie3)/PANMA-im/tie3-PA3-tie2-PA2-tie1-PA1/tie/micro shrink-layer/Sealant layer.

PA/tie/nano bulk-layer/tie/(PA1-tie1-PA2-tie2-PA3-tie3)/PANMA-im/tie3-PA3-tie2-PA2-tie1-PA1/tie/nano shrink-layer/Sealant layer.

PETG/tie/nano bulk-layer/tie/(PA1-tie1-PA2-tie2-PA3-tie3)/EVA/PVdC/EVA/tie3-PA3-tie2-PA2-tie1-PA1/tie/nano shrink-layer/Sealant layer.

Example for Multilayer Hi-Ax Film with PANMA-im, EVOH and PVdC as Barrier Layers with Micro-Layer Block of COC/Tie and Micro-Layers for Bulk and Shrink Layer (10-38 Layers)

PETG/tie/micro bulk-layer)/(COC1-PE1-COC2-PE2-COC3-PE3)/Tie/EVOH/Tie/PE3-COC3-PE2-COC2-PE1-COC1/tie/micro shrink-layer/Sealant layer.

PETG/tie/microbulk-layer)/(COC1-PE1-COC2-PE2-COC3-PE3)/Tie/PANMA-im/Tie PE3-COC3-PE2-COC2-PE1-COC1/tie/micro shrink-layer/Sealant layer

PETG/tie/micro bulk-layer)/(COC1-PE1-COC2-PE2-COC3-PE3)/Tie/PANMA-im/tie/EVOH/Tie/PE3-COC3-PE2-COC2-PE1-COC1/tie/micro shrink-layer/Sealant layer

PA/tie/microbulk-layer)/(COC1-PE1-COC2-PE2-COC3-PE3)/Tie/PANMA-im tie/EVOH/Tie/PE3-COC3-PE2-COC2-PE1-COC1/tie/micro shrink-layer/Sealant layer

Example for Multilayer Bi-Ax Film with PANMA-im, EVOH and PVdC as Barrier Layers with Micro-Layer Block of PETG/Tie or PA/Tie and Single Layers for Bulk and Shrink Layer

PETG1-tie1-PETG2-tie2/bulk-layer/tie/PA/tie/EVOH/tie/PA/tie/shrink-layer/Sealant layer.

PETG1-tie1-PETG2-tie2/bulk-layer/tie/PA/tie/PANMA-im/tie/PA/tie/shrink-layer/Sealant layer.

PA1-tie1-PA2-tie2/bulk-layer/tie/PA/tie/PANMA-im/tie/PA/tie/shrink-layer/Sealant layer.

PA1-tie1-PA2-tie2/bulk-layer/tie/EVA/PVdC/EVA/tie/shrink-layer/Sealant layer.

Other Examples of Multilayer Bi-Ax Films

PETG/tie/micro bulk-layer/tie/PA/EVOH/PA/tie/micro shrink-layer/Sealant layer

PA/tie/micro bulk-layer/tie/PA/EVOH-tie-EVOH-tie/PA/tie/micro shrink-layer/Sealant layer.

PP/tie/micro bulk-layer/tie/PA/EVOH/PA/tie/micro shrink-layer/Sealant layer.

PA/tie/micro bulk-layer/tie/PA/EVOH1-tie1-EVOH2-tie2-EVOH3-tie3/PA/tie/micro shrink-layer/Sealant layer.

PA1-tie1-PA2-tie2/bulk-layer/tie/EVA/PVdC/EVA/tie/shrink-layer/Sealant layer.

PETG/bulk-layer/tie/PVdC/micro-layer of EVA1-EVA2/PVdC/EVA/shrink-layer/Sealant layer.

PA666/bulk-layer/tie/PVdC/micro-layer of EVA1-EVA2/PVdC/EVA/shrink-layer/Sealant layer. Outer layer may also be PA11, PA12 or terpolymer PA or suitable blends.

Exemplary film structures may be made by any of the exemplary methods described below.

### Example 2: Double Bubble Method

In an embodiment, a multilayer film with excellent moisture, oxygen barrier and mechanical properties has been fabricated. The structure of the multilayer film is: PETG/tie/bulk-layer/tie/(PA1-EVOH1-tie1-EVOH2-PA2)/tie/PANMA-im/tie/shrink/sealant layer. The outer layer, PETG, had a density of 1.3 g/cc, an intrinsic viscosity of 0.70 dl/g and a thickness of 2 microns. The bonding (tie) layer was an ethylene-based copolymer with a melt index of 2.7 and a density if 0.90 g/cc. The bulk layer was VLDPE with a density of 0.912 and melt index of 1.0. The core barrier layer was a micro-layer block of PA666/EVOH (copolymer nylon) having a melting point of 195° C., the tie layer was LLDPE-maleic anhydride, and the oxygen barrier layer was PANAM-im (Barex) having an MFR 3.0 and a density of 1.15 g/cc. The next tie layer was an ethylene-based copolymer, the shrink layer was a plastomer with a density of 0.902 glee and a melt index of 1.0, and the sealant layer was a blend of ULDPE having a density of 0.912, a melt index of 1.0 and a plastomer having a density of 0.902 and a melt index of 1.0.

A biaxially oriented heat shrinkable multilayer film of this structure was produced by the known double bubble method. A tubular thirteen layer film (where n=2) was produced using this method with eleven extruders. The polymers were extruded by the extruders through an annular die, and a tubular primary tube of thirteen layers extruded downwardly therefrom. The tubular thirteen layer primary tube was cooled in a cold water tank located under the die and containing water at a temperature of about 25° C. or lower. The bubble formed by a multilayer primary tube was squeezed by nip roll in the cold water tank which collapsed the primary tube from bubble form to sheet form.

The cold water in the tank quenched the tubular primary tube to maintain the amorphous state of the plastic material and to lower the temperature thereof so that substantially no crystalline growth occurred in the polymer tube that would inhibit the subsequent process of orientation.

The collapsed primary tube from the cold water tank was passed over idler rolls and through a pair of nip rolls. The collapsed film was then passed from the nip rolls through an infrared heating section and blown to form a second bubble, which was subsequently collapsed by a collapsing frame. The collapsed film was then passed through a pair of nip rolls, which were rotated three to five times faster than the previous nip rolls, with the air in the bubble being entrapped therein by the rolls. This resulted in biaxial orientation of the film lengthwise (MD) and breadthwise (TD). The collapsed film was passed over further idler rolls and wound in the form of a roll.

The collapsed film was passed by annealing station to stabilize the film and prevent shrinkage on the rolls. The bi-axially oriented, heat shrinkable film may be slit to remove trim, if desired.

The resulting bi-axially oriented heat shrinkable film had a physical thickness of 40 microns and showed excellent oxygen, moisture and mechanical properties. The film was flexed 100 times without any visible mechanical cracks appearing. The film was tested for shrinkage and showed an excellent shrinkage of 45% in TD and 40% in MD at 90° C.

### Example 3: Double Bubble with Third Bubble for Annealing

In another embodiment, a multilayer film (15 layers) with improved moisture, oxygen barrier and mechanical properties has been fabricated. The structure of the multilayer film was: PETG/tie/bulk layer/tie/(PA₁-tie₁-PA₂-tie₂)/tie/EVOH/tie/PANMA-im/tie/shrink layer/Sealant layer. This film contained 1 micro-layer block of PA/tie with 4 micro-layers. The outer layer was PETG having the following characteristics: a density of 1.33 g/cc, an intrinsic viscosity of 0.79 dl/g, a melting point of 225° C. and a thickness of 2 microns. The bonding layer was an ethylene-based copolymer having the following properties: a melt index of 2.7 and a density of 0.90 g/cc. The bulk layer was LLDPE with a density of 0.916 and a melt index of 1.0. The barrier layer was a micro-layer block of PA6 (homopolymer nylon) having a melting point of 220° C., including a tie layer of LLDPE-maleic anhydride, and the central oxygen barrier was a combination of EVOH (ethylene 38 mole %) with a density 1.17 g/cc and PANAM-im (Barex) having an MFR of 3.0 and a density of 1.15 g/cc. The tie layer was an ethylene-based copolymer, the shrink layer was a plastomer with a density of 0.902 and melt index of 1.2, and the sealant layer was a blend of LLDPE having a density of 0.918 and melt index 1.0, with a plastomer having a density of 0.902 and a melt index of 1.0.

A biaxially oriented heat shrinkable multilayer film of this structure was produced by the double bubble method with third bubble for annealing using thirteen extruders. The polymers were extruded by extruders through an annular die, and a primary tube of fifteen layers extruded downwardly therefrom. The fifteen layer primary tube was cooled in a cold water tank located under the die and containing water at a temperature of about 25° C. or lower. The bubble formed by the multilayer primary tube was squeezed by a nip roll in the cold water tank which collapsed the film from bubble form to sheet form.

The cold water in the tank quenched the primary tube to maintain the amorphous state of the plastic material and to lower the temperature thereof so that substantially no crystalline growth occurred in the polymers of the primary tube which would inhibit the subsequent process of orientation.

The collapsed primary tube from the cold water tank was passed over idler rolls and through a pair of nip rolls. The collapsed film was passed from the nip rolls through an infrared heating section and blown to form a second bubble, which was subsequently collapsed by a collapsing frame. The collapsed film was then passed through a pair of nip rolls, which were rotated three to five times faster than the nip roll, with the air in the bubble being entrapped therein by the rolls. This resulted in a biaxial orientation of the film lengthwise (MD) and breadthwise (TD). The collapsed film was then passed over the idler rolls and then from nip rolls through an infrared heating section and blown to form a third bubble, which was subsequently collapsed by a collapsing frame. The collapsed film was hen passed through a pair of nip rolls, which were rotated slightly slower than the previous nip roll, with the air in the bubble being entrapped therein by the rolls. This resulted in annealing of film. The collapsed film was then passed over further idler rolls and wound in the form of a roll. The biaxially oriented heat stabilized low shrink film may be slit to remove trim, if desired.

The resulting bi-axially oriented heat shrinkable film had a physical thickness of 40 microns and exhibited excellent oxygen, moisture and mechanical properties. The film was flexed 100 times without any visible mechanical cracks appearing. The film was tested for shrinkage and showed a low shrinkage (<5%) at 90° C.

### Example 4: Cast Sheet

A multilayer film in accordance with another embodiment was produced by a cast film process. The structure of the film was: PETG/tie/bulk layer/tie/(PA₁-tie₁-PA₂-tie₂-PA₃-tie₃-PA₄-tie₄-PA₅-tie₅/tie/EVOH/tie/tie₅-PA₅-tie₄-PA₄-tie₃-PA₃-tie₂-PA₂-tie₁-PA₁/tie/shrink layer/Sealant layer. The total thickness of the multilayer cast film was generally in the range of from 100 microns to 300 microns and was preferably from about 120 microns to about 250 microns for a thereto-forming application.

A cast sheet of thirty layers was produced using fourteen extruders. Extruded polymers were fed to a cast film die, and the cast film was extruded downwards therefrom over a chill roll which cooled the film. The cast sheet was then passed through nip rolls and idler rolls and wound into a roll.

Use of these inventions enables a multilayer film to be produced with improved barrier to oxygen or moisture or high mechanical properties depending upon the selection of the structures. The film can be used for, for example, shrink bag applications, lidding film (heat stabilized) and for thermoforming.

1. A multilayer film having at least five component layers and optionally, a series of bonding layers tying said component layers together, said component layers comprising:
a central oxygen barrier layer;
a first polymeric barrier layer on a first side of said central oxygen barrier layer;
a second polymeric barrier layer on a second side of said central oxygen barrier layer;
an outer layer adjacent said first polymeric barrier layer; and
a sealant layer adjacent said second polymeric barrier layer;
wherein at least one layer comprises two polymers that exhibit different properties.

2. The multilayer film of claim 1, wherein at least one layer comprises a micro-block or a nano-block comprising from 2 to 5 different polymers.

3. The multilayer plastic film of claim 1, wherein said central oxygen barrier layer comprises an oxygen barrier polymer selected from the group consisting of ethylene vinyl acetate copolymer (EVOH), polyvinylidene chloride (PVdC), impact modified acrylonitrile-methyl acrylate copolymer (PANMA-im), polyamide and mixtures thereof.

4. The multilayer film of claim 3, wherein the central oxygen barrier layer additionally comprises at least one micro-block or nano-block.

5. The multilayer film of claim 4, wherein the micro-block or nano-block comprises a polyamide.

6. The multilayer film of claim 1, wherein central oxygen barrier layer has a thickness in the range of from about 1 to about 24 microns.

7. The multilayer film of claim 1, wherein each of said first and second polymeric barrier layers is selected from:
a polymer layer that exhibits a water vapour permeability of less than 2 g·mil/100 in 2 days at 100° F. and 90% relative humidity;
a polymer layer that exhibits an oxygen permeability of less than about 2.5 cm³-mil/100 in 2 to 24 hrs-atm;
a polymer layer that provides bulk;
a polymer layer which exhibits shrink having a melt index in the range of about 0.5 to 10; and
a polymer layer that provides mechanical strength.

8. The multilayer film of claim 7, wherein said first polymeric layer is a bulk layer comprising a polymer selected from the group consisting of high density polyethylene (HDPE), medium density polyethylene (MDPE), low density polyethylene, linear low density polyethylene (LLDPE), metallocene LLDPE (mLLDPE), very low density polyethylene (VLDPE), metallocene polyethylene (mPE), single site metallocene catalyst (SSC) based LLDPE, polypropylene, cyclic olefin copolymers (COC), ethylene-vinyl acetate (EVA), ethylene methacrylate (EVA), ethylene acrylic acid, ionomers, acid copolymers, plastomers, elastomers, polyolefins, styrene-based copolymers, polystyrene, styrene block copolymer (SBC), and blends thereof.

9. The multilayer film of claim 7, wherein said second polymeric layer is a shrink layer comprising a polymer selected from the group consisting of: high density polyethylene (HDPE), medium density polyethylene (MDPE), low density polyethylene, linear low density polyethylene (LLDPE), metallocene LLDPE (mLLDPE), very low density polyethylene (VLDPE), metallocene polyethylene (mPE), single site metallocene catalyst (SSC) based LLDPE, polypropylene, cyclic olefin copolymers (COC), ethylene-vinyl acetate (EVA), ethylene methacrylate (EMA), ethylene acrylic acid, ionomers, acid copolymers, plastomers, elastomers, polyolefins, styrene-based copolymers, polystyrene, styrene block copolymer (SBC), and blends thereof.

10. The multilayer film of claim 1, wherein each of said polymeric barrier layers have a thickness in the range of from about 2 to about 50 microns.

11. The multilayer film of claim 1, wherein said outer layer comprises a polymer having an inherent viscosity (IV) in the range of about 3.2 to 4.7.

12. The multilayer film of claim 1, wherein said outer layer comprises a polymer selected from the group comprising polyethylene terephthalate (PET), polyethylene terephthalate glycol-modified (PETG), amorphous polyethylene terephalate (APET), polyethylene naphthalate (PEN), polybutylene terephthalate (PBT), polylactic acid, cyclic olefin copolymers (COC), polyolefin, polyamides, polyethylene, polypropylene and blends thereof.

13. The multilayer film of claim 1, wherein the outer polymeric layer has a thickness in the range of about 1.5 to about 9 microns.

14. The multilayer film of claim 1, wherein the sealant layer comprises a polymer having a melt index of from about 0.5 to about 6.0 decigram per minute.

15. The multilayer film of claim 1, wherein the sealant layer comprises a polymer selected from the group consisting of: polyolefin, polyethylene, polypropylene, polyolefin, plastomers, elastomers, ethylene acrylic acid, ethylene methacrylic acid, ethylene-vinyl acetate (EVA), ethylene methyl acrylate copolymer (EMAC), ionomers, acid copolymers, and blends thereof.

16. The multilayer film of claim 1, wherein the sealant layer has a thickness in the range of from about 10 to about 40 microns.

17. The multilayer film of claim 1, wherein the bonding layer comprises a polymer selected from the group consisting of: ethylene vinyl acetate-maleic anhydride copolymer, ethylene methyl acrylate-maleic anhydride, low density polyethylene-maleic anhydride, linear low density polyethylene-maleic anhydride, acid copolymer and blends including any of these polymers.

18. The multilayer film of claim 17, wherein each bonding layer has a thickness in the range of from about 1 to about 10 microns.

19. The multilayer film of claim 1, having a thickness in the range of about 5 to 300 microns.

20. The multilayer film of claim 1, wherein the outer layer is selected from the group consisting of PETG, polyamide, polypropylene and LLDPE, the first polymeric layer is a bulk layer, the central oxygen barrier layer comprises EVOH with a microblock on each side thereof, wherein the microblock comprising two polyamide layers and the EVOH and polyamide layers are tied together with bonding layers, and the second polymeric layer is a shrink layer.

21. The multilayer film of claim 1, wherein the outer layer is a polymer selected from the group consisting of PETG, polyamide and polypropylene, the first polymeric layer is a bulk layer in the form of a microblock, the central oxygen barrier layer comprises EVOH and polyamide, and the second polymeric layer is a shrink layer in the form of a microblock.

22. The multilayer film of claim 22, wherein the central oxygen barrier comprises an EVOH layer with a polyamide layer on each side thereof, and the outer layer is PETG.

23. The multilayer film of claim 22, wherein the central oxygen barrier comprises, EVOH-bonding layer-EVOH-bonding layer, with a polyamide layer on each side thereof, and the outer layer is a polyamide layer.

24. The multilayer film of claim 22, wherein the central oxygen barrier comprises an EVOH layer with a polyamide layer on each side thereof, and the outer layer is polypropylene.

25. The multilayer film of claim 22, wherein the central oxygen barrier comprises, EVOH-bonding layer-EVOH-bonding layer-EVOH-bonding layer, with a polyamide layer on each side thereof, and the outer layer is a polyamide layer.

26. The multilayer film of claim 22, wherein the central oxygen barrier comprises an EVOH central layer with a microblock on each side thereof, wherein the microblock comprises alternating polyamide and bonding layers, the outer layer is polymer selected from the group consisting of PETG, polyamide and polypropylene, the first polymeric layer is a bulk layer in the form of a nanoblock, and the second polymeric layer is a shrink layer in the form of a nanoblock.

27. The multilayer film of claim 1, wherein the central oxygen barrier layer comprises EVA and PVdC, the first polymeric layer is a bulk layer, and the second polymeric layer is a shrink layer.

28. The multilayer film of claim 27, wherein the central oxygen barrier layer comprises a central PVdC layer with an EVA layer on each side thereof, and the outer layer comprises a microblock comprising alternating polyamide and bonding layers.

29. The multilayer film of claim 27, wherein the central oxygen barrier layer comprises a PVdC layer bonded to a microblock comprising EVA bonded to a PVdC layer bonded to an EVA layer, and the outer layer comprises a polymer selected from the group consisting of PETG and a polyamide.

30. The multilayer film of claim 29, wherein the polyamide is selected from the group consisting of nylon 666, nylon 11, nylon 12, a polyamide terpolymer and blends thereof.

31. A sheet comprising a multilayer film as defined in claim 1 having a thickness of about 250 to 5000 microns.

32. A method of making a multilayer film as defined in claim 1 selected from double bubble, double bubble with third bubble for annealing, blown process, cast process, sheet process, extrusion coating process and blow molding.
